(19) United States
(12) Patent Application Publication
(10) Pub. No.: US 2014/0324713 A1
(43) Pub. Date: Oct. 30, 2014

(54) SYSTEM AND METHOD FOR JUROR MANAGEMENT

(71) Applicant: Adam Gordon, San Diego, CA (US)

(72) Inventor: Adam Gordon, San Diego, CA (US)

(21) Appl. No.: 14/261,237

(22) Filed: Apr. 24, 2014

Related U.S. Application Data
(60) Provisional application No. 61/815,577, filed on Apr. 24, 2013.

(51) Int. Cl. G06Q 50/18; G06Q 10/10

(52) U.S. Cl. CPC G06Q 50/18; G06Q 10/10
USPC 705/311

(57) ABSTRACT

A server stores organizational information about courtroom physical layout, stores a data set of information about each potential juror and stores issue information about the subject matter of the trial. Research about potential jurors is conducted and information generated is stored in the corresponding data set. Voir dire questions and answers are also stored in the corresponding data sets. The data sets are analyzed to assist in the jury selection process. The data sets are augmented with post trial information from selected jurors. The system analyzes the data sets to identify trends in juror behavior and provide statistical analysis of the likelihood of a selected juror having demographic information favorable or unfavorable to a particular issue. Such analysis information is stored and used during the jury selection process to automatically identify potential jurors who may be predisposed to view key issues at trial in a favorable or unfavorable fashion.

### BACKGROUND

1. Field of the Invention

The present invention is generally related to courtroom proceedings and more specifically related to management of the selection process for potential jurors and management of the monitoring process for actual jurors.

2. Related Art

The conventional jury selection process has long been managed by organizing the information generated from responses to questions during jury selection using Post-it® Notes or other ad hoc, informal, or in-house solutions. After being provided a “grid” of the courtroom by court staff, trial lawyers and trial consultants are most often seen scribbling and shifting Post-it® Notes during the jury selection process. The limitations of such solutions in cases with a smaller number of prospective jurors includes the loss of information about jurors, the inability to reproduce the actual courtroom layout, and the constraints of writing information about jurors on the Post-it® Notes themselves. In cases involving a larger number of prospective jurors there are issues such as the inability to fit the requisite number of Post-it® Notes on the seating grid provided by the court, the difficulty in conducting voir dire from the limited amount of information on the Post-it® Notes, and the disorientation involved with not being able to see “runs” of favorable or unfavorable jurors in a large group setting.

Some computerized software solutions have been provided to assist in the jury selection process, but these software solutions suffer from similar data entry and data organization limitations. Additionally, while these software solutions are typically an improvement over conventional Post-it® Notes for data entry and data organization the ability to capture an increased volume of potential juror information makes it extremely difficult for a single user to handle all of the data entry of potential juror information generated in the courtroom. It is also extremely difficult for a single user to organize the significantly increased amount of data while also questioning potential jurors during the voir dire process.

Moreover, adding an assistant in the courtroom can help by dividing the labor or data entry, data organization and voir dire, but the single user interface of the computer constrains the ability of the attorney handling voir dire to use the information that is being simultaneously input to the software solution by the assistant. Therefore, what is needed is a system and method that overcomes these significant problems found in the conventional systems as described above.

### SUMMARY

In order to address the limitations of the conventional solutions noted above, described herein are systems and methods for juror management that allow for multi- user collaboration during jury selection, during trial and post trial. A server system is provided that stores organizational information about the physical layout of the courtroom, stores a data set of information about each potential juror and stores issue information about the subject matter of the trial. Prior to jury selection, the physical layout of the courtroom stored in the system can be customized to reflect the actual physical layout of the courtroom and the seat locations of the potential jurors. Additionally, key issues in the subject matter of the trial can both be entered into the system and related to predetermined voir dire questions along with their corresponding answers so that an actual answer from a potential juror can trigger a desired notification to the attorney handling voir dire to inquire further or challenge the prospective juror.

When the voir dire process is about to start, the names of the potential jurors are received and entered into the system. A data set for each potential juror is established and the potential jurors are mapped to individual seats in the courtroom. Users that are not present in the courtroom (e.g., paralegals or other assistants at the attorney's office or jury consultants in another city or another state), can access the server system and input, delete or modify information about each of the potential jurors. Specifically, the system is configured to obtain background information about each potential juror, obtain social media information about each potential juror, and conduct research about each potential juror to obtain other information about each potential juror. All of this obtained information is entered into the system and stored in the data set for each potential juror.

In the courtroom, an attorney handling the voir dire process is able to see the information about each potential juror populate into the system in real time as the data is entered from both the remote locations and the courtroom. Additionally, assistants in the courtroom or outside the courtroom can enter data into the system, including responses to questions provided by each potential juror. These responses alone or in combination with other obtained information can be analyzed by the system to customize subsequent voir dire questions in accordance with a jury selection strategy or trial strategy or theme.

Once a jury has been empaneled, the system is configured to obtain additional information about each selected juror and further enhance the data set of information for each selected juror. Additionally, the system is configured to monitor social media sites related to each seated juror and provide a notification of any trial related activity in such social media sites. The system is also configured to facilitate the post trial juror interview process in a fashion similar to the voir dire process and then store the selected juror information captured in each of the selected juror data sets for subsequent data analysis. The system is also configured to monitor social media sites related to each selected juror after the trial is completed and provide a notification of any trial related activity in such social media sites. The system is also configured to present a series of questions related to the type of trial, the results of the trial, the voting of the particular jurors, and the issues litigated during the trial in order to capture as much information as possible when the trial is completed.

The system is also configured to analyze the data set information stored for selected jurors and potential jurors to identify trends in juror behavior and provide statistical analysis of the likelihood of a selected juror having specific demographic information being favorable or unfavorable to a particular issue. Such statistical analysis information is stored by the system and used during the jury selection process to automatically identify certain potential jurors who may be statistically predisposed to view key issues related to an impending trial in a favorable or unfavorable fashion. This information can be stored such that for aggregation and analysis of past data, a particular juror's name would be anonymous.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts and in which:

FIG. 1 is a network diagram illustrating an example system for juror management according to an embodiment of the invention;

FIG. 2 is a block diagram illustrating an example timeline for a jury trial according to an embodiment of the invention;

FIG. 3 is a block diagram illustrating an example server in a system for juror management according to an embodiment of the invention;

FIG. 4 is a block diagram illustrating an example courtroom device in a system for juror management according to an embodiment of the invention;

FIG. 5 is a flow diagram illustrating an example process for juror management according to an embodiment of the invention; and

FIG. 6 is a block diagram illustrating an example wired or wireless processor enabled device that may be used in connection with various embodiments described herein.

### DETAILED DESCRIPTION

Certain embodiments disclosed herein provide systems and methods for juror management. For example, one method disclosed herein allows for multi-user collaboration to research potential jurors and populate a data set of information about a potential juror so that the information can be analyzed and used to optimize voir dire questions and jury selection. The system also allows for monitoring of a selected juror's social media information to determine whether or not a selected juror is commenting about an ongoing trial.

After reading this description it will become apparent to one skilled in the art how to implement the invention in various alternative embodiments and alternative applications have time constraints for selection. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims. For example, the functional aspects of the system can be applied to sports player drafts, fantasy sports player drafts, sports book betting, buying stocks, bonds and commodities, auctions, fundraisers, and the like. The functional aspects of the system can be applied to other endeavors as well, as will be understood by those skilled in the art.

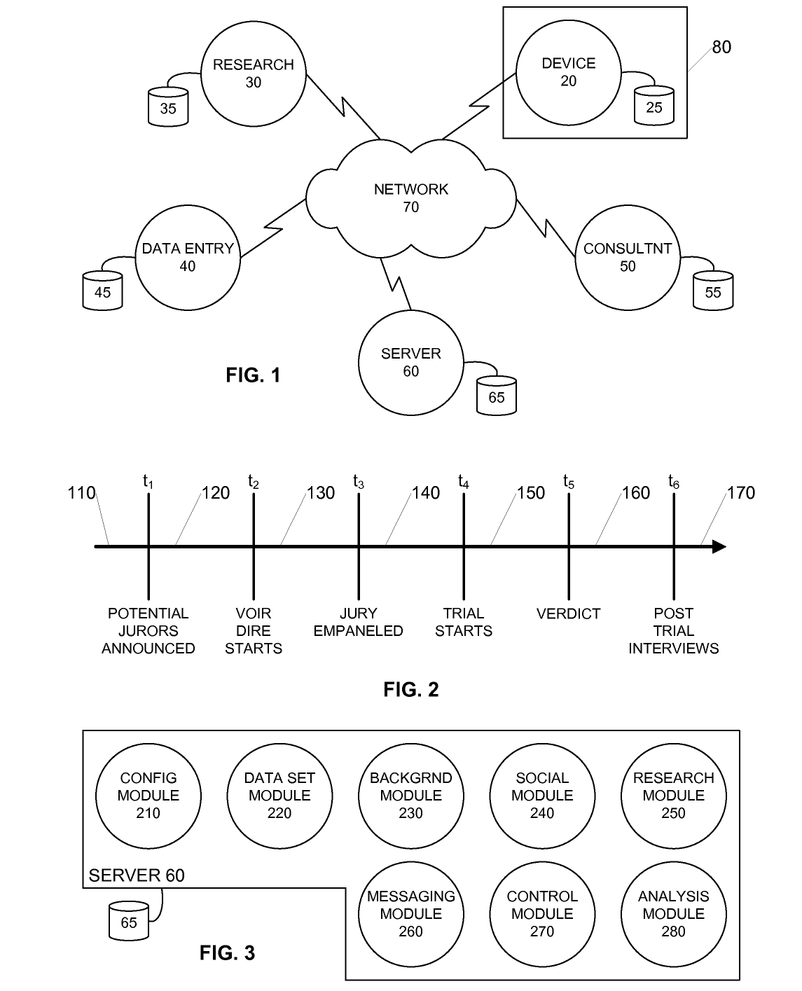

FIG. 1 is a network diagram illustrating an example system for juror management according to an embodiment of the invention. In the illustrated embodiment, a device 20 that is located inside a courtroom 80 is communicatively coupled with a server 60 that is outside the courtroom 80. Additionally, a research device 30, data entry device 40 and consultant device 50 are each communicatively coupled with the server 60 via the network 70. In one embodiment, a plurality or all of the devices 20, 30, 40, 50 and 60 can be inside of the courtroom 80 and the network 70 can be an ad hoc or private wireless network. For example, in an embodiment where the system is employed during a mock trial where all trial team members are co-located in the same courtroom (or mock courtroom) in preparation for the real trial. In another example, the judge and/or courtroom staff may have devices that allow them to access and use the system. The judge and courtroom staff may use the system for a variety of purposes, including but not limited to: data entry, security monitoring, communication amongst themselves and to track the movement of potential jurors during jury selection, which includes voir dire and the peremptory challenge process. Each of the devices 20, 30, 40, 50 and 60 can be implemented as a processor enabled device such as later described with respect to FIG. 6 and each of the devices are configured with data storage areas 25, 35, 45, 55 and 65, respectively. The data storage areas may include both volatile and non- volatile memory as also later described with respect to FIG. 6. As will be understood by those skilled in the art, appropriate security measures are employed to safeguard information that is transmitted between devices via the network 70 and/or stored in the various data storage areas. In one embodiment, the device 20 may include a camera to capture photographic information about a potential juror. The photographic information can be used, for example, to conduct background research, social media research, or other research on a particular potential juror. Similarly, the device 20 may include a microphone to capture questions presented to a potential juror and the corresponding answers. Advantageously, the device 20 may also be configured to process audio received through the microphone into text data. Alternatively, the device 20 may send the audio data to the server 60 for conversion to text. In one embodiment, the camera and/or microphone may be separate physical devices that are communicatively coupled with the device 20, e.g., by wireless communication means. For example, a pair of glasses with an integrated digital camera, microphone and wireless communication means can be employed. Alternatively, separate camera and microphone devices may be employed.

In operation, prior to the trial related courtroom proceedings (e.g., voir dire, trial, and post trial), the server system is accessed from one of the devices 20, 30, 40 or 50 and configured and customized for the upcoming trial. Most likely, this pre-configuration access will be from a device outside of the courtroom, including device 20 which may be a mobile laptop of the trial attorney, for example. When setting up the trial in the server 60, the system allows for the courtroom layout to be created, selected and/or customized, allows key issues to be created, selected and/or customized and desired voir dire questions to be created, selected and/or customized. Advantageously, the system maintains and updates a stored set of courtroom layouts, key trial issues, and desired voir dire questions. All of the courtroom layout, key trial issues, and desired voir dire questions information is saved by the server 60 in association with the upcoming trial. In one embodiment, desirable voir dire questions can be brought to the attention of the trial attorney (e.g., suggested by the server 60) based on an analysis of the key issues that were created, selected and/or customized as related to the trial.

When the trial related courtroom proceedings are beginning, the device 20 receives a list of potential juror names and/or anonymous jury numbers. The list of potential juror names and/or anonymous jury numbers may be received in a variety of formats (e.g., paper or electronic). These names are transmitted from the device 20 to the server 60 for storage in the data storage area 65 in association with the trial that was previously configured. The server 60 then creates a data set for each of the potential jurors and begins to populate the data set. In one embodiment, potential jurors that are determined to be examined first during the voir dire process are prioritized such that their data sets are populated first. The data sets include fields to capture information that is relevant to the voir dire and trial processes. For example, whether or not the potential juror has ever served on a jury before may be a specific field in the data set. The various fields in the data set can be populated from data entry station 40, for example using information that was generated at research device 30. Similarly, research device 30 can be configured to automatically access certain public databases to obtain information about each potential juror such as whether the potential juror has ever been convicted of a felony. The research device 30 can automatically populate that information into the data set. Advantageously, the trial attorney can view that information from device 20 as soon as it is stored in the data set at the server 60. In one embodiment, critical information can be emphasized in the user interface on the device 20 to ensure that the trial attorney using the device 20 in the courtroom 80 is made aware of the critical information during the voir dire or trial process. Furthermore, the determination of what is and is not critical information can be configured into the server 60 during the configuration process prior to the commencement of the trial related courtroom proceedings.

Prior to and during the voir dire process, potential juror information can be input into the various data sets stored at server 60. This input may be provided from inside the courtroom via device 20 or from outside the courtroom via devices 30, 40 and 50, for example. Additional inside the courtroom devices and outside the courtroom devices may also be employed. Advantageously, the server 60 provides a real time communication capability so that all members of the trial team, whether inside the courtroom or outside the courtroom can effectively communicate with each other in real time.

In one embodiment, background related information about each juror is researched and obtained and populated into the data set for the particular potential juror. Background related information may include criminal record information, driving record information, employment history, educational history, residential history, credit scores, bankruptcy, liens, civil judgments, residence, political campaign donations and the like. Other types of background information may also be obtained and populated into the data set as will be understood by those skilled in the art.

Similarly, social media related information is also researched and obtained and populated into the data set for the particular potential juror. Social media related information may include autobiographical information from any social media source, such as facebook, twitter, instagram, google plus, deviantart, livejournal, tagged, orkut, cafemom, ning, meetup, mylife, multiple, localmind and linkedin and the like. Social media related information may also include non-autobiographical information about a potential juror from these same and other social media sources. Other types of social media information may also be obtained and populated into the data set as will be understood by those skilled in the art.

As previously mentioned, the data in each of the data sets is analyzed by the server 60 and the trial attorney in the courtroom 80 can be provided with a rich collection of information about each potential juror via the device 20 to assist the trial attorney in the trial related courtroom proceedings, initially beginning with voir dire. During the voir dire process, certain potential jurors may be dismissed for a variety of reasons (e.g., judicial discretion, peremptory challenge) and the server 60 allows the user interface that shows each potential juror in a particular seat of the courtroom layout to be updated, for example by “dragging and dropping” a potential juror from one seat in the courtroom layout to another seat or an excused/challenged position. This allows the trial team to accurately track the physical location of the potential jurors in the actual courtroom. Once the voir dire process is complete and a set of selected jurors has been determined (i.e., seated jurors and alternates), the data sets for the non-selected potential jurors can be deleted from the server 60 or the data can be maintained by the server 60 for later statistical analysis to facilitate future jury selection.

During trial, the server 60 is configured to monitor social media outlets and other media outlets such as newspapers and the like for information about the ongoing trial in connection with any selected juror. Advantageously, this monitoring can alert the trial team to any juror misconduct or other information that may be germane to the procedure for the specific trial.

After the trial, the server 60 is similarly configured to monitor social media outlets and other media outlets such as newspapers and the like for information about the ongoing trial in connection with any voting juror (e.g., alternate jurors may be excluded from post trial monitoring if the alternate juror(s) did not participate in rendering the verdict. Advantageously, this monitoring can alert the trial team to any juror misconduct or information that may be relevant to the specific trial.

Furthermore, similar to the voir dire process, the server 60 may store in the data sets certain post trial interview questions to be asked of each selected juror and the corresponding juror responses. This information can be stored at the server 60 and analyzed to facilitate post trial analysis of individual juror demographics and individual juror viewpoints on key issues in the trial. Advantageously, statistical analysis of such information including juror demographics, juror answers to voir dire questions, juror verdicts and voting trends can be undertaken to improve and optimize future jury selection and future trial. For example the theme of a trial may be modified after an analysis of selected juror demographics to optimize the emphasis of certain facts during trial to maximize the potential for jurors to decide key issues of the trial in a fashion to achieve a desirable result.

FIG. 2 is a block diagram illustrating an example timeline for a jury trial according to an embodiment of the invention. In the illustrated embodiment, a trial includes a configuration period 110 where the server 60 can be configured with initial courtroom layout, key issues and desired voir dire questions. The courtroom layout may also be customized when the trial attorney enters the courtroom 80 to account for any layout changes. At time t1, the pool of potential jurors is announced and the name of each potential juror is provided to the server 60, for example via the device 20. During the pre-voir dire period 120, background information and social media information is obtained and entered into the data sets stored at the server 60 so that the information is available to the trial attorney in the courtroom 80 via the device 20. Additionally, in some situations, potential jurors are required to fill out a jury questionnaire during the pre-voir dire period 120. In those situations, the jury questionnaire questions and answer are also provided to the server 60, for example via the device 20, so that the information can be incorporated into the particular data set for the corresponding potential juror.

During the voir dire period 130, additional background information and social media information is entered into the data sets that are stored at the server 60. Also, information from a potential juror's answers to voir dire questions in the courtroom 80 is also provided to the server 60 and stored in the data set associated with the particular potential juror. At time t3, the selected jury is empaneled. The selected jury includes both the actual jurors and alternate jurors.

During the pre-trial period 140, additional research on each of the selected jurors can be undertaken to provide the server 60 with as much additional information as possible about each selected juror. Additionally, monitoring of social media outlets and other media outlets can be commenced in connection with each of the selected juror names and related to the specific trial and/or any issues that are related to the trial. At time t4, the trial starts and during the trial period 150 even more research on each of the selected jurors can be undertaken to provide the server 60 with as much additional information as possible about each selected juror. Additionally, monitoring of social media outlets and other media outlets can be continued in connection with each of the selected juror names and related to the specific trial and/or any issues that are related to the trial.

The verdict is issued at time t5 and during the post-trial period 160 monitoring of social media outlets and other media outlets can be continued in connection with each of the selected juror names and related to the specific trial and/or any issues that are related to the trial. Additionally, the demographic information stored in the various data sets (one for each selected juror) can be analyzed to optimize a set of post trial questions to be asked to the selected jurors (which may or may not include the alternates) during post trial interviews at time t6. Responses to these questions can be provided to the server 60 (e.g., via the device 20) for storage in the data set for the particular juror. During the analysis period 170, the voir dire questions and answers from an individual juror along with the demographic information about that individual juror, the polled verdict from that individual juror and the post trial interview questions and answers from the individual juror can be analyzed. Similar analysis can be undertaken for each of the selected jurors to identify trends and relationships between answers to voir dire questions, individual juror demographics and trial outcome.

FIG. 3 is a block diagram illustrating an example server 60 in a system for juror management according to an embodiment of the invention. In the illustrated embodiment, the server 60 comprises a configuration module 210, a data set module 220, a backgrounds module 230, a social module 240, a research module 250, a messaging module 260, a control module 270 and an analysis module 280. The server 60 is configured with a data storage area 65 as previously described.

The configuration module 210 is configured to establish a trial event that stores the data sets corresponding to potential jurors and selected jurors and related voir dire, trial and post trial information in association with each other in the data storage area 65. The configuration module 210 is also configured to allow the physical layout of the courtroom to be predetermined prior to arrival in the courtroom and then customized to reflect the actual layout and the actual organization of the potential jurors. The configuration module is also configured to allow desired voir dire questions to be established prior to the voir dire process. The configuration module 210 is also configured to receive a set of potential juror names for the subject trial.

The data set module 220 is configured to receive the set of potential juror names or anonymous juror numbers from the configuration module and create a data set for each potential juror. Each data set can initially be the same and include the same fields that are expected to be populated with information about each potential juror. Advantageously, the data set module 220 is configured to allow an individual data set to deviate from the initial format to accommodate inclusion of a variety of information types and fields. The data set module 220 is configured to receive information from at least the configuration module 210, the background module 220, the social module 240 and the research module 250 and incorporate that information in the data set for the corresponding potential or selected juror.

The background module 230 is configured to obtain background information about a selected juror and provide the background information to the data set module 210 for storage in the data set corresponding to the potential juror. Background information may include criminal record information, driving record information, employment history, educational history, residential history, credit scores, bankruptcy, liens, civil judgments, residence, political campaign donations and the like. Other types of background information may also be obtained for storage the data set as will be understood by those skilled in the art.

The social module 240 is configured to obtain social media information about a selected juror and provide the social media information to the data set module 210 for storage in the data set corresponding to the potential juror. Social media information may include autobiographical information from any social media source, such as facebook, twitter, instagram, google plus, deviantart, livejournal, tagged, orkut, cafemom, ning, meetup, mylife, multiple, localmind and linkedin and the like. Social media information may also include non-autobiographical information about a potential juror from these same and other social media sources. Other types of social media information may also be obtained for storage in the data set as will be understood by those skilled in the art.

The research module 250 is configured to facilitate research about a potential juror and obtaining of any type of information about a potential juror for storage in the data set in association with the potential juror. The research module 250 is configured to obtain such information about a potential juror and provide such information to the data set module 210 for storage in the data set corresponding to the potential juror. Such other information may include purchased information, free information, investigation results and the like.

The messaging module 260 is configured to allow the individuals on the trial team to communicate in real time via the server 60. For example, one or more trial attorneys using devices 20 inside the courtroom, one or more jury consultants using consultant devices 50 outside the courtroom, one or more paralegals using data entry devices 40 outside the courtroom and one or more researchers using research devices 30 outside the courtroom. Advantageously, the messaging module 260 is configured to provide real time messaging between members of the trial team. Advantageously, the real time messaging allows the members of the trial team inside the courtroom to be alerted to certain critical information in a timely fashion, for example to optimize the jury selection process.

The control module 270 is configured to communicate with one or more remote devices and receive information from and provide information to such devices. For example, the control module 270 is configured to receive information from one or more research devices 30, one or more data entry devices 40, one or more consultant devices 50 and one or more devices 20. The control module 270 is also configured to route received information to the appropriate module for processing, for example background information received from a research device 30 is routed to the data set module 210 for storage in the appropriate data set corresponding to a particular potential or selected juror.

The control module 270 is also configured to engage the analysis module 280 to analyze juror demographic information in connection with voir dire questions and corresponding answers and then update the data set with analysis information about the desirability of the particular potential juror. Additionally, the control module may engage the messaging module 260 to send a message to the trial team with such analysis information.

The analysis module 280 is configured to analyze data stored in the data storage area 65, including for example the voir dire questions and answers from a first juror, the demographic information about the first juror, the polled verdict from the first juror and the post trial interview questions and answers from the first juror. Similar analysis can be to the data sets of each selected juror in the data storage area 65. Advantageously, the analysis can be applied to identify trends and relationships between answers to voir dire questions, individual juror demographics and trial outcome. Such analysis can subsequently inform the juror selection process to eliminate or keep certain potential jurors with certain demographics that answer specifically selected voir dire questions in a predetermined fashion.

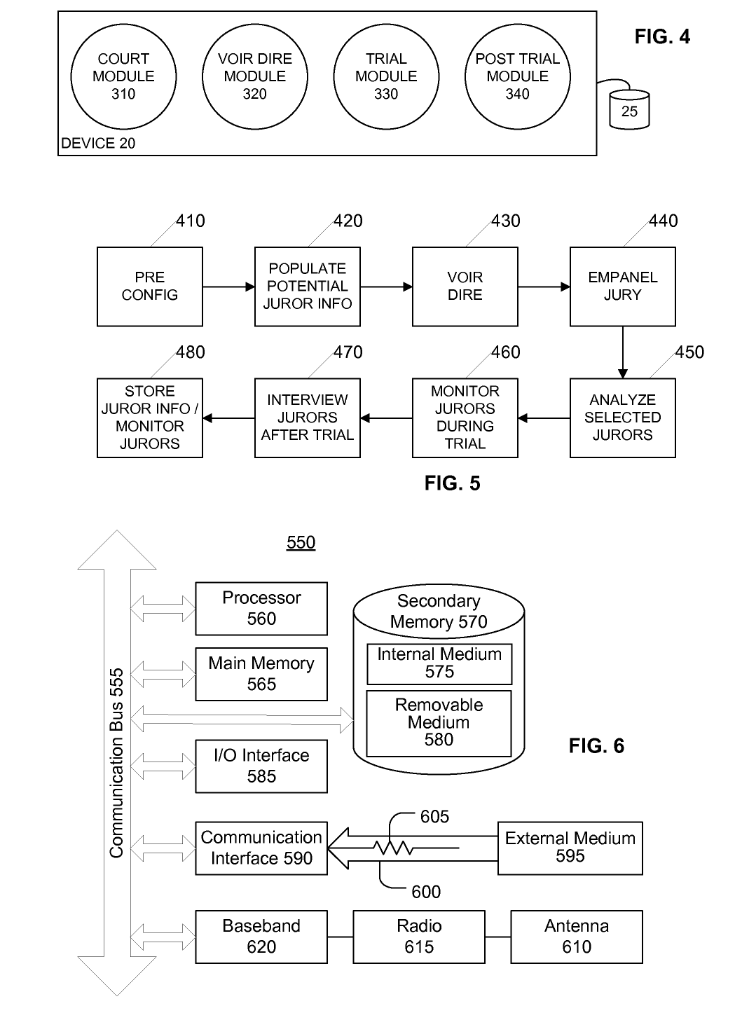

FIG. 4 is a block diagram illustrating an example courtroom device 20 in a system for juror management according to an embodiment of the invention. In the illustrated embodiment, the device 20 comprises a court module 310, a voir dire module 320, a trial module 330 and a post trial module 340. The device 20 is configured with a data storage area 25 as previously described.

The court module 310 is configured to allow selection and configuration or customization of the courtroom layout as well as selection and creation of desired voir dire and post trial interview questions in cooperation with the server 60. This information (courtroom layout and desired voir dire and post trial interview questions) is stored by the server 60 in the data storage area 65 in connection with the trial.

The voir dire module 320 is configured to manage a set of voir dire questions for the trial in cooperation with the server 60 where such information is stored in association with the trial. The set of voir dire questions may include a separate subset of questions for each individual potential juror based on the individual potential juror demographic information, background information, social media information, and other information stored in the data set for the potential juror. The voir dire module 320 can advantageously cooperate with the control module 270 on the server 60 to receive and act upon analysis provided by the analysis module 280.

The trial module 330 is configured to manage trial related information in cooperation with the server 60 where such information is stored in association with the trial. For example, trial related information may include information related to the theme of the trial and related to certain items of information desired to be emphasized based on an analysis of selected juror demographics, key issues in the trial, and answers to particular voir dire questions. The trial module 330 is also configured to cooperate with the control module 270 and the social module 240 to monitor social media outlets during the trial period.

The post trial module 340 is configured to manage post trial related information including individual juror polls for particular verdicts and post trial juror interview questions and answers in cooperation with the server 60 where such information is stored in association with the trial. The post trial module 340 is configured to provide such information to the server 60 for storage in the data set of the corresponding selected juror. The post trial module 340 is also configured to cooperate with the control module 270 and the social module 240 to monitor social media outlets after the trial period.

FIG. 5 is a flow diagram illustrating an example process for juror management according to an embodiment of the invention. The illustrated process may be carried out by a system such as previously described with respect to FIGS. 1-4. Initially, in step 410, the system is preconfigured with information about the upcoming trial and an individual trial data object is initiated to stored all trial related information for the upcoming trial. In the preconfiguration step 410, the courtroom layout can be selected or created, key issues can be selected or created and voir dire questions can be selected or created. Advantageously, voir dire questions can be proposed by the system based on an analysis of the key issues involved in the upcoming trial.

Next, in step 420 the names of the potential jurors or anonymous juror numbers are entered into system once they are received from the court. When the individual names are received, a data set for each potential juror is created and population of information in each data set takes place in step 420. The population may be prioritized based on the organization or order of the potential jurors. Potential juror information may include background information, social media information, purchased information, free information, investigation results, credit related information as well as other information.

In step 430, voir dire begins and the potential jurors are questioned in the courtroom. The questions and answers are provided to the server system and included in the data set for the particular potential juror to aide in further analysis of the potential juror during voir dire. During the voir dire process, additional information about the potential jurors can be input into the server system for storage in the corresponding data sets. Once a sufficient number of potential jurors have been selected to be actual and alternate jurors during the trial, as shown in step 440, further background and other research about the selected jurors may be conducted and stored in the corresponding data sets as indicated in step 450. Additionally, monitoring of social media outlets and other media outlets may be commenced in step 460 to identify any statements made by a selected juror or related to a selected that may have an impact on the trial.

Once the trial is completed, the selected jurors may be polled and/or interviewed in step 470 and the information stored in the data set for each corresponding selected juror as shown in step 480. Additionally, monitoring of social media outlets and other media outlets may continue in step 480 to identify any statements made by a selected juror or related to a selected that may have had an impact on the completed trial.

FIG. 6 is a block diagram illustrating an example wired or wireless system 550 that may be used in connection with various embodiments described herein. For example the system 550 may be used as or in conjunction with a server apparatus or device apparatus as previously described with respect to FIGS. 1-4. The system 550 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 preferably includes a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include a internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include an input/output (“I/O”) interface 585. The I/O interface 585 facilitates input from and output to external devices. For example the I/O interface 585 may receive input from a keyboard or mouse and may provide output to a display. The I/O interface 585 is capable of facilitating input from and output to various alternative types of human interface and machine interface devices alike.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown) that are executable by processor 560.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A technical system comprising:
a server system comprising:
a non-transitory computer readable medium configured to store executable programmed modules;
a processor communicatively coupled with the non-transitory computer readable medium configured to execute programmed modules stored therein;
a configuration module stored in the non-transitory computer readable medium and configured to be executed by the processor, the configuration module configured to prioritize data elements related to potential jurors, organize visual elements of a user interface, receive a plurality of potential juror names and create a data set for each potential juror and store said data sets in the non-transitory computer readable medium;
a research module stored in the non-transitory computer readable medium and configured to be executed by the processor, the research module configured to obtain information related to a first potential juror and store said information in a first data set corresponding to said first potential juror;
a control module stored in the non-transitory computer readable medium and configured to be executed by the processor, the control module configured to communicate with a mobile system via a communication network and send potential juror information to the mobile system and receive potential juror information from the mobile system and update the data set for the first potential juror with the received potential juror information; and
a mobile system comprising:
a voir dire module stored in the non-transitory computer readable medium and configured to be executed by the processor, the voir dire module configured to receive input corresponding to answers to questions provided by the first potential juror and send said input to the server system for storage in the first data set corresponding to said first potential juror.

2. A computer implemented method comprising:
presenting on a display a user interface comprising a plurality of visual elements in accordance with a layout of a courtroom;
receiving a plurality of potential juror names;
creating a data set for each potential juror;
storing said data sets in a non-transitory computer readable medium;
receiving first information related to a first potential juror, the first information received from a location outside of said courtroom;
storing said first information in a first data set corresponding to said first potential juror;
receiving second information related to the first potential juror, the second information received from a location inside of said courtroom; and
storing said second information in the first data set corresponding to said first potential juror.
